(19) United States
(12) Patent Application Publication
(10) Pub. No.: US 2005/0010422 A1
(43) Pub. Date: Jan. 13, 2005

(54) Speech processing apparatus and method

(75) Inventors: Hiromi Ikeda, Kanagawa (JP); Makoto Hirota, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/885,060

(22) Filed: Jul. 7, 2004

(30) Foreign Application Priority Data
Jul. 7, 2003 (JP) 2003-193111

(51) Int. Cl. G10L 11/00

(52) U.S. Cl. 704/277

(57) ABSTRACT

Provided are a speech processing apparatus and method capable of selecting a speech processing server connected to a network and a rule to be used in the server, and capable of readily performing highly accurate speech processing. In a speech processing system, a client 102 can be connected across a network 101 to at least one speech recognition server 110 for recognizing speech data. The client 102 receives speech data input from a speech input unit 106, and designates, from the speech recognition servers 110, a speech recognition server to be used to process the input speech. The client 102 transmits the input speech to the designated speech recognition server via a communication unit 103, and receives a processing result (recognition result) of the speech data processed by the speech recognition server by using a predetermined rule.

### CLAIM OF PRIPRITY

This application claims priority from Japanese Patent Application No. 2003-193111 filed on Jul. 7, 2003 and the entire contents of which are incorporated herein by reference.

### FIELD OF THE INVENTION

The present invention is directed to a speech processing technique which uses a plurality of speech processing servers connected to a network.

### BACKGROUND OF THE INVENTION

Conventionally, a speech processing system which uses a specific speech processing apparatus (e.g., a specific speech recognition apparatus in the case of speech recognition, and a specific speech synthesizer in the case of speech synthesis) is constructed as a system for speech processing. Unfortunately, the individual speech processing apparatuses are different in characteristic feature and accuracy. When various types of speech data are to be processed, therefore, high-accuracy speech processing is difficult to perform if a specific speech processing apparatus is used as in the conventional system. Also, when speech processing is necessary in a small-sized information device such as a mobile computer or cell phone, it is difficult to perform speech processing having a large operation amount in a device having limited resources. In a case like this, speech processing can be efficiently and accurately performed by using, for example, an appropriate one of a plurality of speech processing apparatuses connected to a network.

As an example using a plurality of speech processing apparatuses, a method which selects a speech recognition apparatus in response to a specific service providing apparatus is disclosed (e.g., Japanese Patent Laid-Open No. 2002-150039). Also, a method which selects a recognition result on the basis of the confidences of recognition results obtained by a plurality of speech recognition apparatuses connected to a network is disclosed (e.g., Japanese Patent Laid-Open No. 2002-116796). In addition, the specification of Voice XML (Voice Extensible Markup Language) recommended by W3C (World Wide Web Consortium) presents a method which designates, by using a URI (Uniform Resource Identifier), the location of a grammatical rule for use in speech recognition in a document written in a markup language.

In the above prior art, however, when a certain speech recognition apparatus (speech processing apparatus) is designated, it is impossible to separately designate a grammatical rule (word reading dictionary) for use in the apparatus. Also, only one speech processing apparatus can be designated at one time. Therefore, it is difficult to take any appropriate countermeasure if, for example, the designated speech processing apparatus is down or if an error has occurred on this speech processing apparatus. Furthermore, a user cannot select a rule for selecting one of a plurality of speech processing apparatuses connected to a network, so the user's requirement is not necessarily met.

### SUMMARY OF THE INVENTION

The present invention has been proposed to solve the conventional problems, and has as its object to provide a speech processing apparatus and method capable of selecting, in accordance with the purpose, a speech processing server connected to a network and a rule to be used in the server, and capable of readily performing highly accurate speech processing.

To achieve the above object, the present invention is directed to a speech processing apparatus connectable across a network to at least one speech processing means for processing speech data, comprising:

acquiring means for acquiring speech data;

designating means for designating, from the speech processing means, a plurality of speech processing means to be used to process the speech data, and a priority order of the plurality of speech processing means;

transmitting means for transmitting the speech data to the speech processing means designated by the designating means; and

receiving means for receiving the speech data processed by the speech processing means according to a predetermined rule.

To achieve the above object, the present invention is directed to a speech processing method using at least one speech processing means which can be connected across a network and processes speech data, comprising:

an acquisition step of acquiring speech data;

a designation step of designating, from the speech processing means, a plurality of speech processing means to be used to process the speech data, and a priority order of the plurality of speech processing means;

a transmission step of transmitting the speech data to the speech processing means designated in the designation step; and

a reception step of receiving the speech data processed by the speech processing means by using a predetermined rule.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a client and servers in a speech processing system according to the first embodiment of the present invention;

FIG. 2 is a view showing an example of the way the scores of SR (Speech Recognition) servers are stored in a storage unit 104 of a client 102 according to the first embodiment;

FIG. 3 is a view showing the relationships between the SR (Speech Recognition) servers, grammars (grammatical rules) for recognizing a speech, and the client in the first embodiment;

FIG. 4 is a flowchart for explaining the flow of processing between the client 102 and an SR (Speech Recognition) server 110 in the speech processing system according to the first embodiment of the present invention;

FIG. 5 is a view showing an example of encoding of speech data in the first embodiment;

FIG. 6 is a view showing examples of the descriptions of documents concerning designation of a speech recognition server A and grammars according to the first embodiment;

FIG. 7 is a view showing examples of the descriptions of documents concerning designation of a speech recognition server B and grammars according to the first embodiment;

FIG. 8 is a view showing examples of the descriptions of documents concerning designation of a speech recognition server C and grammars according to the first embodiment;

FIG. 9 is a view showing an example of the description of a request transmitted from a client 102 to an SR server A (110) in the speech processing system according to the first embodiment;

FIG. 10 is a view showing an example of the description of a grammar according to the first embodiment;

FIG. 11 is a view showing an example of a response which the client 102 receives from the SR server 110 in the first embodiment;

FIG. 12 is a view showing an example of the description of a document written in a markup language when two speech recognition servers are designated in a speech processing system according to the second embodiment of the present invention;

FIG. 13 is a flowchart for explaining the flow of processing between a client 102 and SR (Speech Recognition) servers 110 in the speech processing system according to the second embodiment of the present invention;

FIG. 14 is a view showing an example of the description of a document written in a markup language when two speech recognition servers are designated in a speech processing system according to the third embodiment of the present invention;

FIG. 15 is a flowchart for explaining the flow of processing between a client 102 and SR (Speech Recognition) servers 110 in the speech processing system according to the third embodiment of the present invention;

FIG. 16 is a view showing an example of the description of a document written in a markup language when three speech recognition servers are designated in a speech processing system according to the fourth embodiment of the present invention;

FIG. 17 is a flowchart for explaining the flow of processing between a client 102 and SR (Speech Recognition) servers 110 in the speech processing system according to the fourth embodiment of the present invention;

FIG. 18A is a view for explaining an example of a request transmitted to an SR server A, and an example of a response to the request in the fourth embodiment;

FIG. 18B is a view for explaining an example of a request transmitted to an SR server B, and an example of a response to the request in the fourth embodiment;

FIG. 18C is a view for explaining an example of a request transmitted to an SR server C, and an example of a response to the request in the fourth embodiment;

FIG. 19 is a view showing an example of the description of a document written in a markup language when two speech recognition servers are designated in a speech processing system according to the fifth embodiment of the present invention;

FIG. 20 is a flowchart for explaining the flow of processing between a client 102 and SR (Speech Recognition) server 110 in the speech processing system according to the fifth embodiment of the present invention;

FIG. 21 is a view for explaining examples of requests transmitted to SR servers A and B, and examples of responses to the requests in the fifth embodiment;

FIG. 22 is a view showing an example of the description of a document written in a markup language when a speech recognition server is designated in a speech processing system according to the sixth embodiment of the present invention;

FIG. 23 is a flowchart for explaining the flow of processing between a client 102 and SR (Speech Recognition) server 110 in the speech processing system according to the sixth embodiment of the present invention;

FIG. 24 is a view for explaining the relationship between speech synthesizing servers, word pronunciation dictionaries for synthesizing speech, and a client in the seventh embodiment of the present invention;

FIG. 25 is a view showing examples of the descriptions of documents concerning a speech synthesizing server A and word pronunciation dictionary in the speech synthesizing system according to the seventh embodiment;

FIG. 26 is a view showing examples of the descriptions of documents concerning a speech synthesizing server B and word pronunciation dictionary in the speech synthesizing system according to the seventh embodiment;

FIG. 27 is a view showing examples of the descriptions of documents concerning a speech synthesizing server C and word reading dictionary in the speech synthesizing system according to the seventh embodiment; and

FIG. 28 is a view showing an example of a word pronunciation dictionary in the seventh embodiment.

### DETAILED DESCRIPTION OF THE PREFERRED EMBODIMENTS

Embodiments of the use of speech data by a speech processing technique according to the present invention will be described below with reference to the accompanying drawings.

<First Embodiment>

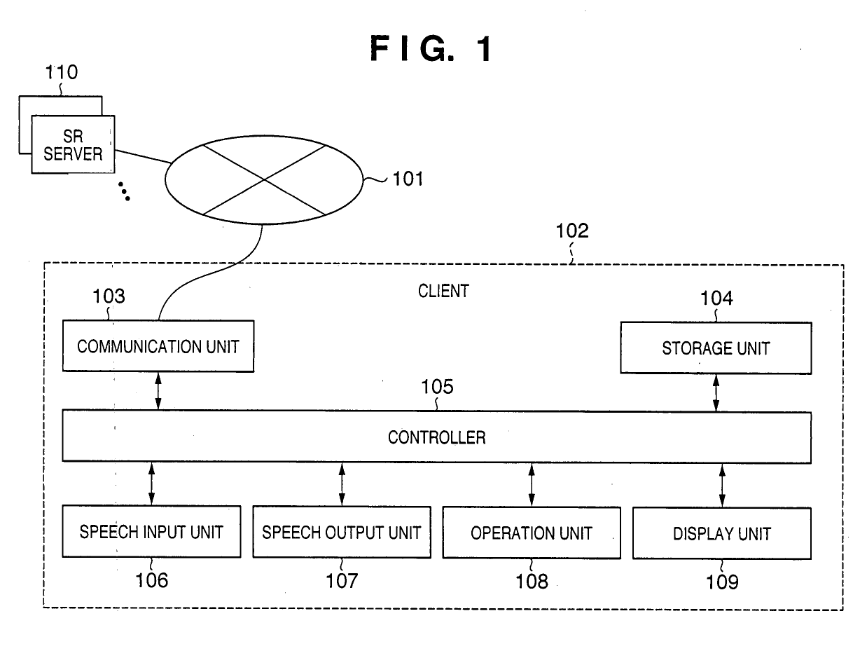

FIG. 1 is a block diagram showing a client and severs of a speech processing system according to the first embodiment of the present invention. As shown in FIG. 1, the speech processing system according to this embodiment includes a client 102 connected to a network 101 such as the Internet or a mobile communication network, and one or a plurality of speech recognition (SR) servers 110.

The client 102 has a communication unit 103, storage unit 104, controller 105, speech input unit 106, speech output unit 107, operation unit 108, and display unit 109. The client 102 is connected to the network 101 via the communication unit 103, and communicates data with the SR servers 110 and the like connected to the network 101. The storage unit 104 uses a storage medium such as a magnetic disk, optical disk, or hard disk, and stores, for example, application programs, user interface control programs, text interpretation programs, recognition results, and the scores of the individual servers.

The controller 105 is made up of a work memory, microcomputer, and the like, and reads out and executes the programs stored in the storage unit 104. The speech input unit 106 is a microphone or the like, and inputs speech uttered by a user or the like. The speech output unit 107 is a loudspeaker, headphones, or the like, and outputs speech. The operation unit 108 includes, for example, buttons, a keyboard, a mouse, a touch panel, a pen, and/or a tablet, and operates this client apparatus. The display unit 109 is a display device such as a liquid crystal display, and displays images, characters, and the like.

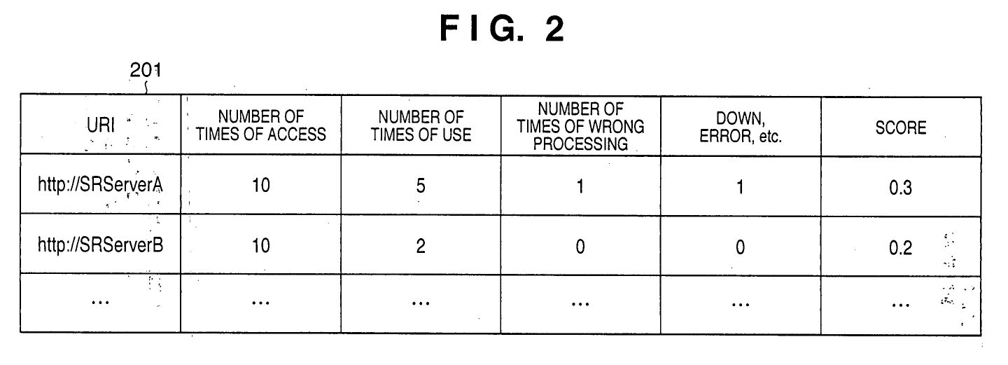

FIG. 2 is a view showing an example of the way the scores of the SR (Speech Recognition) servers are stored in the storage unit 104 of the client 102 according to the first embodiment. For example, the score is increased when the client 102 uses a result returned from the speech recognition server 110, and decreased when the result is wrong (when wrong recognition is performed). The server scores are held by using this predetermined reference. Whether a result is wrong can be determined in accordance with, for example, whether the user has tried speech recognition again.

Also, when a multimodal user interface including a plurality of modalities is used, for example, when a speech UI and GUI are used together, correction is sometimes performed by a modality, such as a keyboard or GUI, different from speech. When a recognition result received from a server is thus corrected on the client side, the score of the server is decreased. It is also possible to add the reference that, for example, the score is increased when the server normally accepts a request transmitted by the client, and decreased when the server cannot normally accept the transmitted request because, for example, the server is down or an error has occurred on the server. In the example shown in FIG. 2, the storage unit 104 records, for example, the URI (Uniform Resource Identifier), the number of times of access, the number of times of use of a recognition result, the number of times of wrong recognition, the number of times of down, error, and the like, and the score of each server. Each score is calculated from, for example, the number of times of access, the number of times of use of a recognition result, the number of times of wrong recognition, and the number of times of down, error, and the like described above.

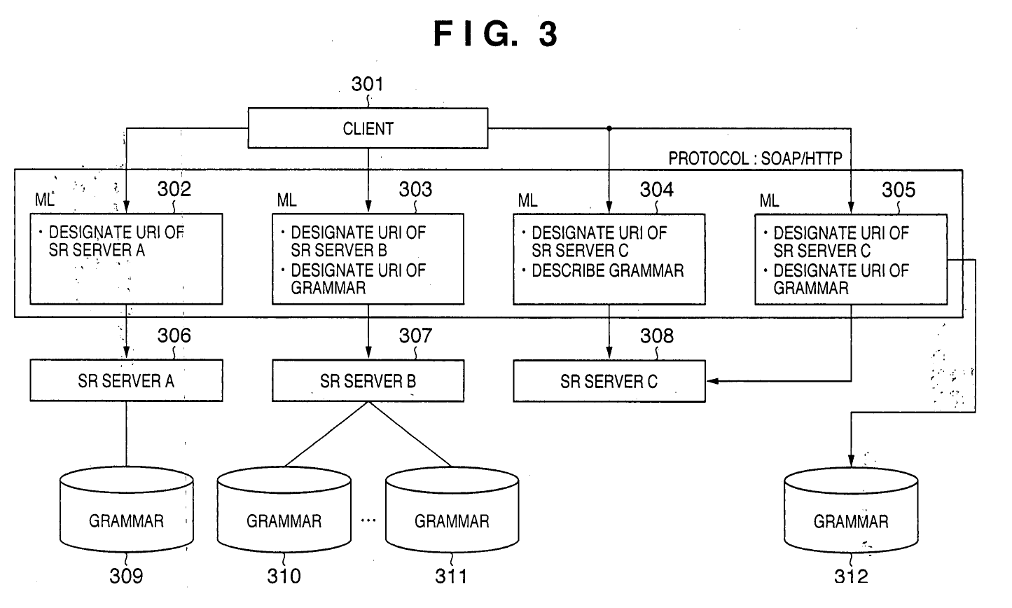

FIG. 3 is a view for explaining the relationships between SR (Speech Recognition) servers, grammars (grammatical rules) for recognizing a speech, and a client in the first embodiment. Reference numeral 301 in FIG. 3 denotes a client such as a portable terminal as shown in FIG. 1; 306 to 308, SR servers taking the form of Web service; and 309 to 312, grammars (grammatical rules) managed by or stored in the individual SR servers. These components can communicate with each other by using SOAP (Simple Object Access Protocol)/HTTP (Hyper Text Transfer Protocol). Note that each of the speech recognition servers 306 to 308 is the prior art. In this embodiment, a method of using the SR servers as described above from the client 301 will be explained.

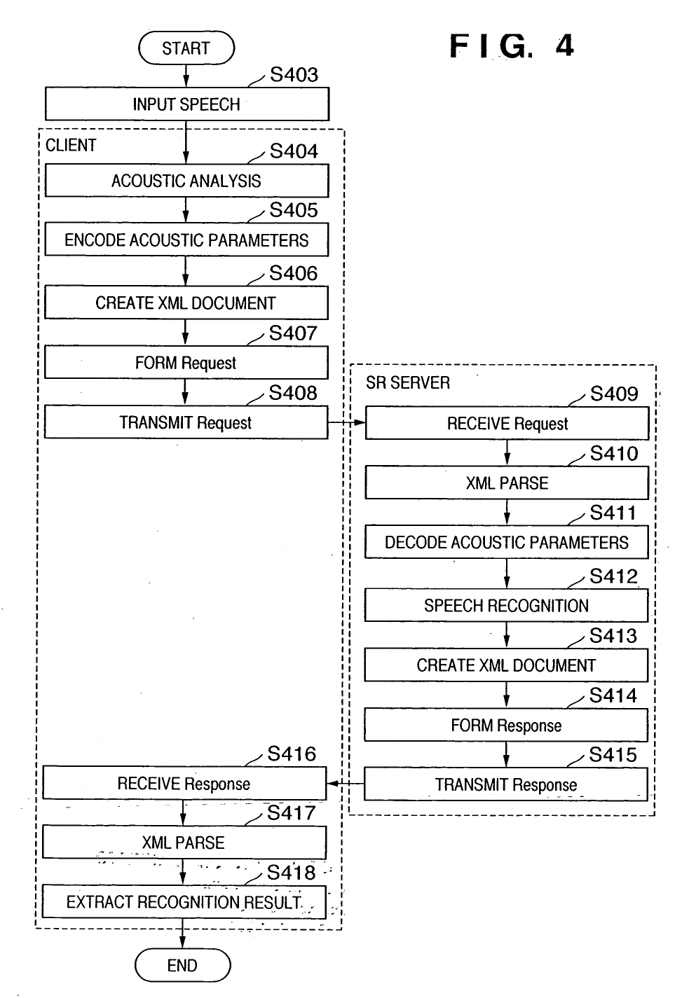

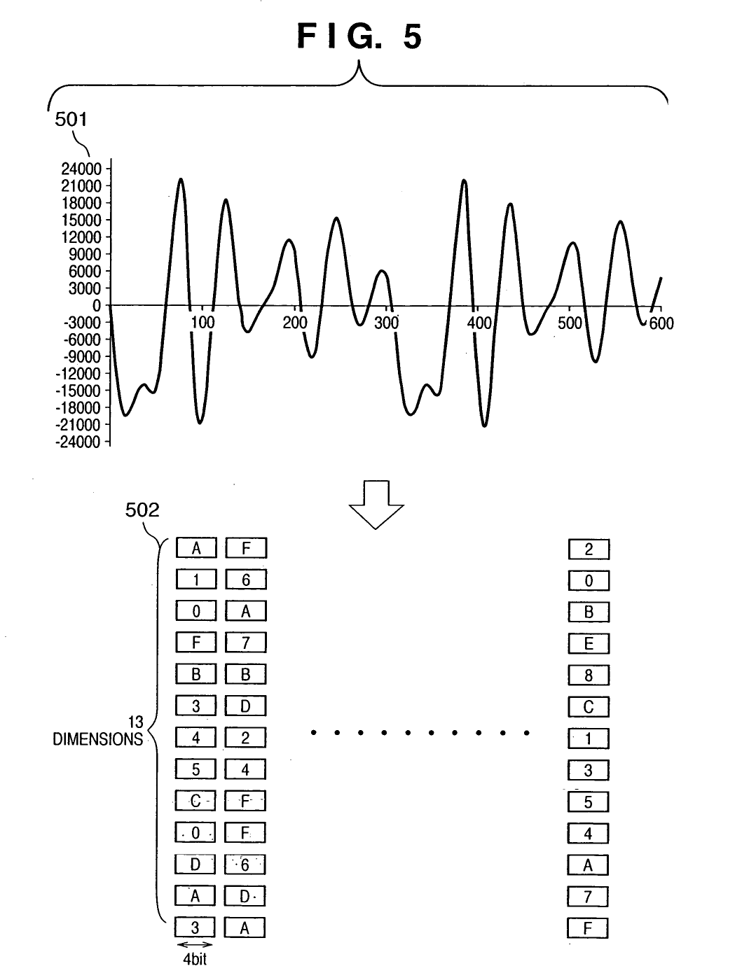

FIG. 4 is a flow chart for explaining the flow of processing between the client 102 and SR server 110 in the speech processing system according to the first embodiment of the present invention. First, speech is input to the client 102 (step S403). The input speech undergoes acoustic analysis (step S404), and the calculated acoustic parameters are encoded (step S405). FIG. 5 is a view showing an example of encoding of speech data in the first embodiment.

The client 102 describes the encoded speech data in XML (Extensible Markup Language) (step S406), forms a request by attaching additional information called an envelope in order to perform communication by SOAP (step S407), and transmits the request to the SR server 110 (step S408).

The SR server 110 receives the request (step S409), interprets the received XML document (step S410), decodes the acoustic parameters (step S411), and performs speech recognition (step S412). Then, the SR server 110 describes the recognition result in XML (step S413), forms a response (step S414), and transmits the response to the client 102 (step S415).

The client 102 receives the response from the SR server 110 (step S416), parses the received response written in XML(step S417), and extracts the recognition result from tags representing the recognition result (step S418). Note that the client-server speech recognition techniques such as acoustic analysis, encoding, and speech recognition explained above are the conventional techniques (e.g., Kosaka, Ueyama, Kushida, Yamada, and Komori: “Realization of Client-Server Speech Recognition Using Scalar Quantization and Examination of High-Speed Server”, research report “Speech Language Information Processing”, No. 029-028, December 1999).

That is, the speech processing apparatus (client 102) in the speech processing system according to the present invention can be connected across the network 101 to one or more speech recognition servers 110 as speech processing means for processing (recognizing) speech data. This speech processing apparatus is characterized by inputting (acquiring) speech from the speech input unit 106, designating, from the speech recognition servers 110 described above, a speech recognition server to be used to process the input speech, transmitting the input speech to the designated speech recognition server via the communication unit 103, and receiving the processing result (recognition result) of the speech data processed by the speech recognition server by using a predetermined rule.

Also, the speech processing apparatus (client 102) further includes one or a plurality of holding units connected to the speech recognition servers, or a means for designating one or a plurality of grammatical rules for speech recognition held in one or a plurality of holding units directly connected to the network 101. The communication unit 103 is characterized by receiving the recognition result of input speech recognized (processed) by the speech recognition server by using the designated grammatical rule or rules.

A method of processing speech data in the speech processing system according to this embodiment will be described below with reference to FIG. 3.

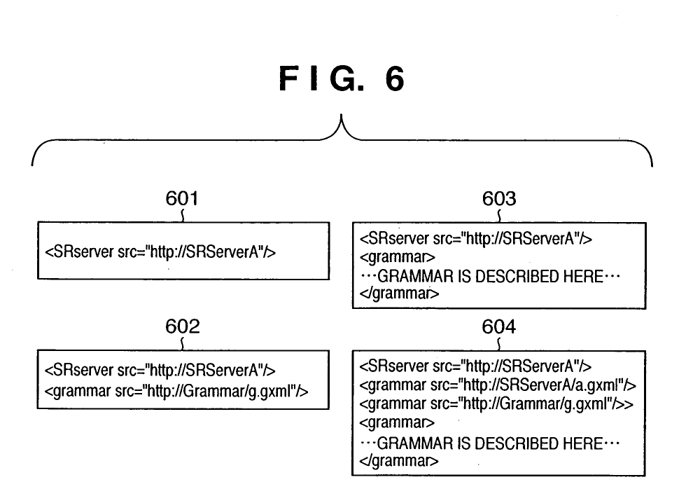

First, a case in which the client 301 uses the SR (Speech Recognition) server A (306) taking the form of Web service in FIG. 3 will be explained below. In this case, the client 301 designates the location of the SR server A (306) by using a URI (Uniform Resource Identifier), as indicated by 601 in FIG. 6 in a document described in the markup language. FIG. 6 is a view showing examples of the descriptions of documents concerning designation of the speech recognition server A and a grammar in the speech processing system according to the first embodiment.

In this embodiment, as shown in FIG. 3, the grammar 309 is registered in the SR server A (306). Therefore, the SR server A (306) uses the grammar 309 unless the client 301 explicitly designates a grammar to be used. For example, if the client 301 wants to use another grammar such as the grammar 312, the client 301 designates, by using a URI, the location of the grammar to be used in a document written in the markup language, as indicated by 602 in FIG. 6. It is also possible to directly describe the grammar written in the markup language as indicated by 603 in FIG. 6, instead of designating the grammar as indicated by 602.

That is, the client 102 according to this embodiment is characterized by designating a speech recognition server on the basis of designating information in which the location of the speech recognition server is described in the markup language. The client 102 is also characterized by designating a grammatical rule held in each holding unit on the basis of rule designating information in which the location of this holding unit holding the grammatical rule is described in the markup language. This similarly applies to embodiments other than this embodiment.

In this embodiment, the client 102 is characterized by further including the operation unit 108 which functions as a rule describing means for directly describingin the markup language, one or a plurality of grammatical rules used in speech processing in the speech recognition server. This also applies to the other embodiments.

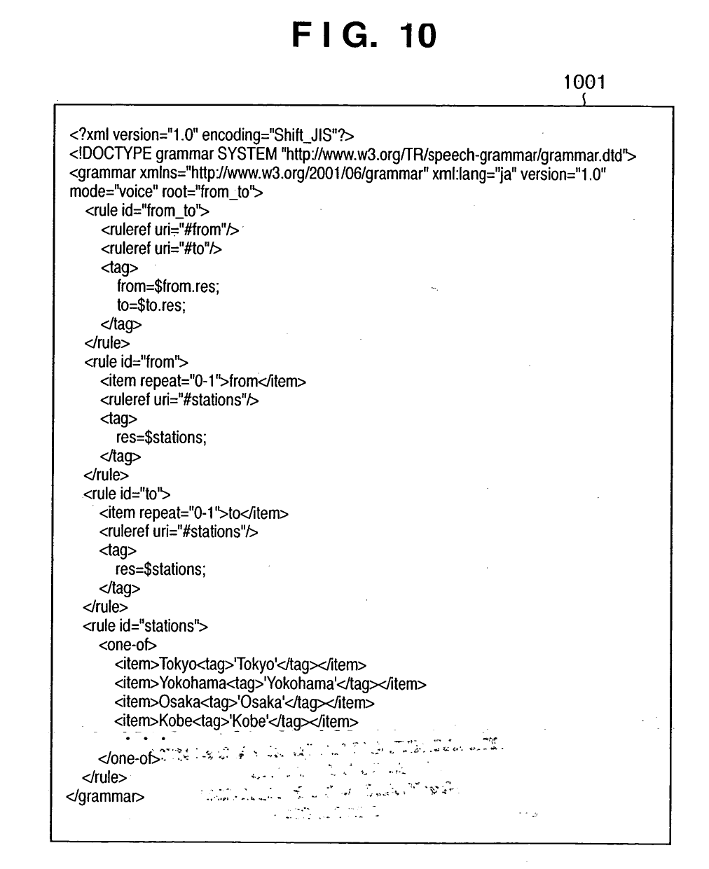

FIG. 10 is a view showing an example of the description of a grammar according to the first embodiment. FIG. 10 shows a grammar describing a rule which recognizes speech inputs such as “from Tokyo to Kobe” and “from Yokohama to Osaka”, and outputs interpretations such as from=“Tokyo” and to=“Kobe”. The grammar describing a rule like this is the prior art recommended by W3C (World Wide Web Consortium), and details of the specification are described in the Web sites of W3C (Speech Recognition Grammar Specification: http://www.w3.org/TR/speech-grammar/, Semantic Interpretation for Speech Recognition: http://www.w3.org/TR/2001/WD-semantic-interpretation-20011116/). Note that a plurality of grammars can be designated as indicated by 604 in FIG. 6, or designation of a grammar by the URI and a description written in the markup language can be combined. For example, to recognize the name of a station and the name of a place, both a grammar for recognizing station names and a grammar for recognizing place names are designated or described.

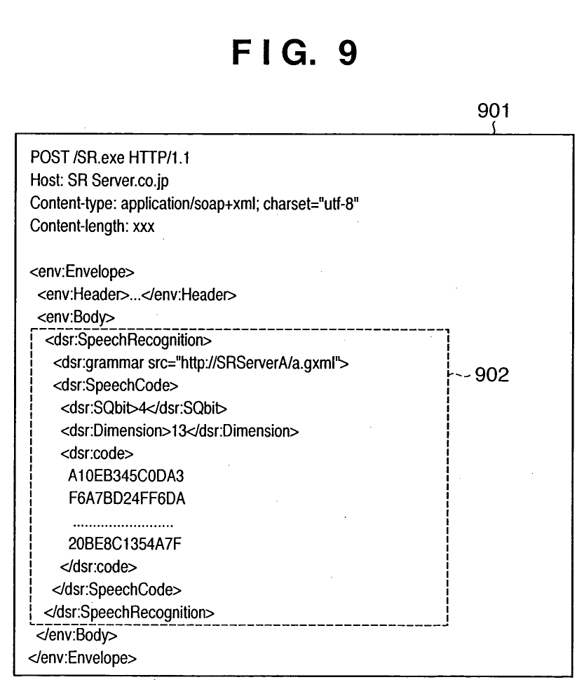

FIG. 9 is a view showing an example of the description of a request transmitted from the client 301 according to the present invention to the SR server A (306). The client 301 transmits the request as indicated by 901 in FIG. 9 to the SR server A (306) (step S408 described earlier). The request 901 describes designation of a grammar which the user wants to use, speech data to be recognized, and the like, in addition to the header. In SOAP communication, a message obtained by attaching additional information called an envelope to an XML document is exchanged by a protocol such as HTTP.

Referring to FIG. 9, a portion (902) enclosed with <dsr:SpeechRecognition> tags is data necessary for speech recognition. As described above, a grammar is designated by a <dsr:grammar> tag. In this embodiment as described previously, a grammar is described in the form of XML as shown in FIG. 10. To perform scalar quantization for speech data as shown in FIG. 5, 13-dimensional, 4-bit speech data, for example, is designated by <dsr:Dimension> tags and <dsr:SQbit> tags as indicated by 902 in FIG. 9, and the speech data is described by <dsr:code> tags.

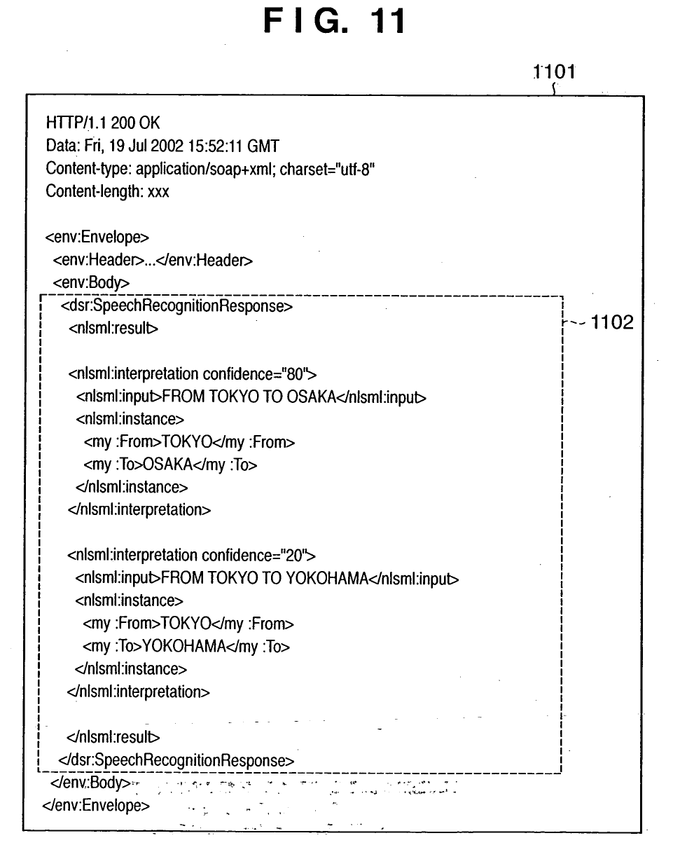

Also, the client 301 receives a response as indicated by 1101 in FIG. 11 from the SR server A (306) which has received the request 901 (step S416 mentioned earlier). That is, FIG. 11 is a view showing an example of the response which the client 301 of the first embodiment receives from the SR server A. The response 1101 describes the result of speech recognition and the like in addition to the header. The client 301 parses tags indicating the recognition result from the response 1101 (step S417), and obtains the recognition result (step S418).

Referring to FIG. 11, a portion (1102) enclosed with <dsr:SpeechRecognitionResponse> tags represents a speech recognition result, <nlsml:interpretation> tags indicate one interpretation result, and an attribute confidence indicates the confidence. Also, <nlsml:input> tags indicate input speech “from ◯◯ to ΔΔ”, and <nslml:instance> tags indicate results ◯◯ and ΔΔ of recognition. As described above, the client 301 can extract the recognition result from the tags in the response. A specification for expressing the above interpretation result is disclosed by W3C, and details of the specification are described in the Web site of W3C (Natural Language Semantics Markup Language for the Speech Interface Framework: http://www.w3.org/TR/nl-spec/).

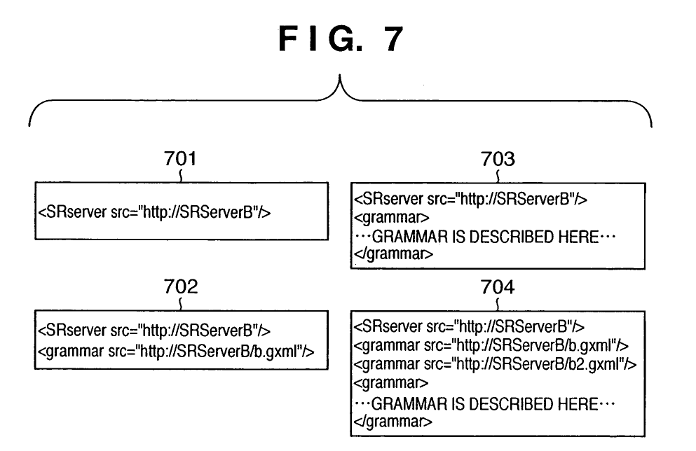

Next, a case in which the client 301 in FIG. 3 uses the SR (Speech Recognition) server B (307) taking the form of Web service will be explained below. In this case, the client 301 designates the location of the SR server B (307) by using a URI (Uniform Resource Identifier), as indicated by 701 in FIG. 7 in a document described in the markup language. FIG. 7 is a view showing examples of the descriptions of documents concerning designation of the speech recognition server B and a grammar in the speech processing system according to the first embodiment.

In this embodiment, as shown in FIG. 3, the grammars 310 and 311 are registered in the SR server B (307). Therefore, the SR server B (307) uses the grammars 310 and 311 unless the client 301 explicitly designates a grammar to be used. For example, if the client 301 wants to use the grammar 310 alone, the grammar 311 alone, or another grammar such as the grammar 312, the client 301 designates, by using a URI, the location of the grammar to be used in a document written in the markup language, as indicated by 702 in FIG. 7. It is also possible to directly describe the grammar in the markup language as indicated by 703 in FIG. 7, instead of designating the grammar as indicated by 702. Note that a plurality of grammars can be designated as indicated by 704 in FIG. 7, or designation of a grammar by the URI and a description written in the markup language can be combined.

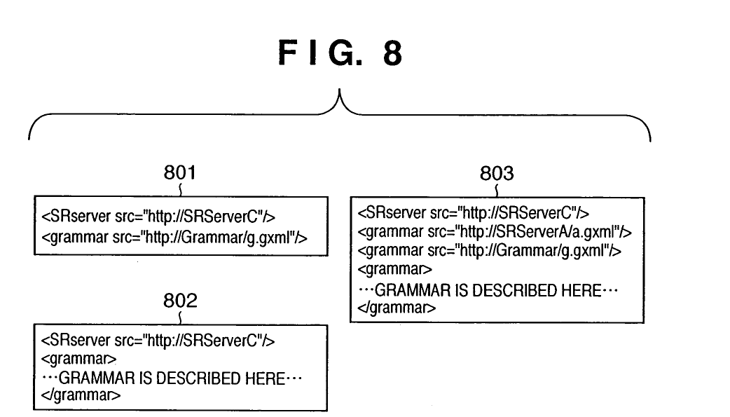

Furthermore, a case in which the client 301 in FIG. 3 uses the SR (Speech Recognition) server C (308) taking the form of Web service will be explained below. In this case, the client 301 designates the location of the SR server C (308) by using a URI (Uniform Resource Identifier), as indicated by 801 in FIG. 8 in a document described in the markup language. FIG. 8 is a view showing examples of the descriptions of documents concerning designation of the speech recognition server C and a grammar in the speech processing system according to the first embodiment.

In this embodiment, no grammars are registered in the SR server C (308) as shown in FIG. 3, so the client 301 must designate a grammar. For example, if the client 301 wants to use the grammar 312, the client 301 designates, by using a URI, the location of the grammar 312 in a document written in the markup language, as indicated by 801 in FIG. 8. It is also possible to directly describe the grammar in the markup language as indicated by 802 in FIG. 8. Note that a plurality of grammars can be designated as indicated by 803 in FIG. 8, or designation of a grammar by the URI and a description written in the markup language can be combined.

A user himself or herself can also designate an SR server and grammar from a browser. That is, this embodiment is characterized in that the location of a speech recognition server or the location of a grammatical rule is designated from a browser.

In the first embodiment as described above, when SR (Speech Recognition) servers connected to a network are to be used, a client can select a speech recognition server and grammar. To allow the client to designate an appropriate SR server and grammar in accordance with contents to be processed, a speech recognition system having high accuracy can be constructed. For example, both the name of a place and the name of a station can be recognized by designating a speech recognition server in which only a grammar for recognizing place names is registered, and by designating a grammar for recognizing station names. Also, since SR servers and the like can be designated by document written in the markup language, an advanced speech recognition system as described above can be readily constructed. Furthermore, an SR (Speech Recognition) server and grammar can be designated from a browser. This allows easy construction of an environment suited not only to an application developer but also to a user himself or herself.

<Second Embodiment>

The second embodiment of the speech processing according to the present invention will be described below. In the first embodiment, a speech recognition server and grammar are designated. In this embodiment, a plurality of speech recognition servers are designated.

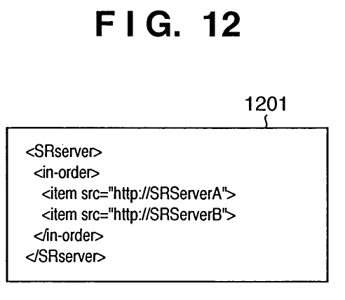

FIG. 12 is a view showing an example of the description of a document written in the markup language when two speech recognition servers are designated in a speech processing system according to the second embodiment of the present invention. Referring to FIG. 12, the URIs of the speech recognition servers are designated by <item/> tags, and the rule that these speech recognition servers are used in accordance with the priority order is designated by <in-order> tags. Accordingly, the priority order in this case is the order described in this document, (i.e., the order of an SR server A and SR server B). However, if a desired server is set in a browser, this set server is given priority.

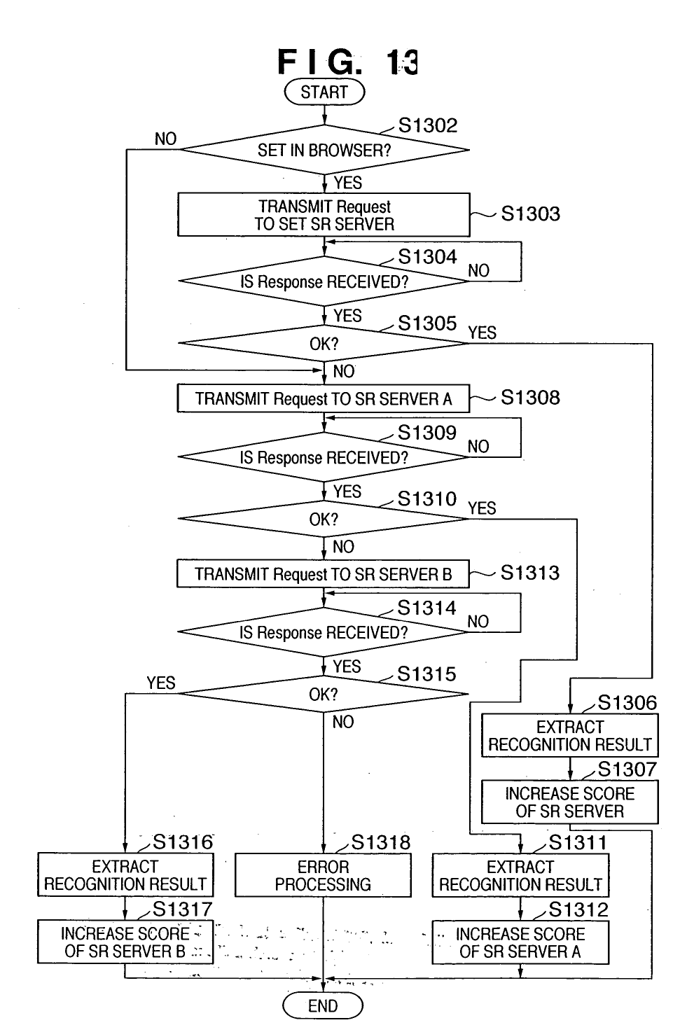

FIG. 13 is a flowchart for explaining the flow of processing between a client 102 and SR (Speech Recognition) servers 110 in the speech recognition server according to the second embodiment of the present invention. First, the client determines whether a speech recognition server to be used is set in a browser (step S1302). If a speech recognition server is set (Yes), the client transmits a request to the set speech recognition server (step S1303).

After that, the client determines whether a response is received from this speech recognition server (step S1304). If the response is received (Yes), the client analyzes the contents of the response, and, on the basis of the description in the header of the response as shown in FIG. 11 described earlier, determines whether the transmitted request is normally accepted by the speech recognition server (step S1305).

If the transmitted request is normally accepted (Yes), the client extracts a recognition result from the response by parsing tags representing the recognition result (step S1306). In addition, the client increases the score as shown in FIG. 2 of the SR server (step S1307). If the request is not normally accepted (No in step S1305) because, for example, the speech recognition server is down or an error has occurred, or if no speech recognition server is set in the browser (No in step S1302), a request is transmitted to the SR server A (step S1308).

Then, the client determines whether a response is received from the SR server A (step S1309). If the response is received (Yes), the client analyzes the contents of the response, and determines whether the transmitted request is normally accepted (step S1310). If the transmitted request is normally accepted (Yes), the client extracts a recognition result from the response by parsing tags representing the recognition result (step S1311). Additionally, the client increases the score as shown in FIG. 2 of the SR server A (step S1312).

On the other hand, if the request is not normally accepted (No in step S1310) because, for example, the SR server A is down or an error has occurred, a request is transmitted to the SR server B (step S1313). The client then determines whether a response is received from the SR server B (step S1314). If the response is received (Yes), the client analyzes the contents of the response, and determines whether the transmitted request is normally accepted (step S1315). If the transmitted request is normally accepted (Yes), the client extracts a recognition result (step S1316), and increases the score as shown in FIG. 2 of the SR server B (step S1317). If the transmitted request is not normally accepted (No), the client performs error processing, for example, notifies the event (step S1318).

A user himself or herself can also designate, from a browser, a plurality of servers, and the rule that these speech recognition servers are used in accordance with the priority order.

That is, the client 102 of the speech processing system according to this embodiment designates a plurality of speech recognition servers to be used to recognize (process) input speech, and the priority order of these speech recognition servers. The client 102 is characterized by transmitting, via a communication unit 103, speech data to a speech recognition server having top priority in the designated priority order, and, if this speech data is not appropriately processed in this speech recognition server, retransmitting the same speech data to a speech recognition server having second priority in the designated priority order. This embodiment is also characterized in that if a predetermined speech recognition server is already set in a browser, this speech recognition server set in the browser is designated in preference to the designated priority order.

In the second embodiment as explained above, when SR (Speech Recognition) servers connected to a network are to be used, a plurality of SR servers are designated, and the priority order is determined. Therefore, even if a certain SR server is down or an error has occurred, the next desired SR server can be automatically used. Consequently, a high-accuracy speech recognition system can be constructed with high reliability. Also, since SR servers and the like can be designated by document written in the markup language, the speech recognition system can be easily constructed. Furthermore, it is possible, from a browser, to designate a plurality of SR servers, and to select speech recognition servers in accordance with the priority order. This allows not only an application developer but also a user himself or herself to easily select an SR server and the like to be used.

<Third Embodiment>

The third embodiment of the speech processing according to the present invention will be described below. In this embodiment, of a plurality of designated speech recognition servers, a recognition result of a speech recognition server having a highest response speed is used.

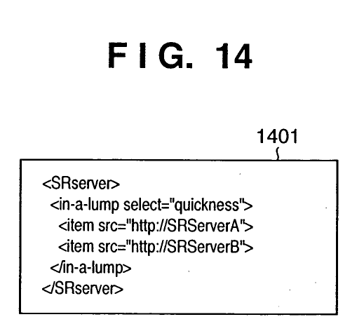

FIG. 14 is a view showing an example of the description of a document written in the markup language when two speech recognition servers are designated in a speech processing system according to the third embodiment of the present invention. Referring to FIG. 14, <item/> tags designate two speech recognition servers A and B by using their URIs, and <in-a-lump> tags indicate a rule in which, in addition to the rule that requests are transmitted to all servers at once, an attribute select=“quickness” designates the rule that a result of a server having a highest response speed is used.

In this case, therefore, a request is transmitted to both the described SR servers A and B, and a recognition result of an SR server having a higher response speed is used. However, if a desired server is set in a browser, this set server is preferentially used.

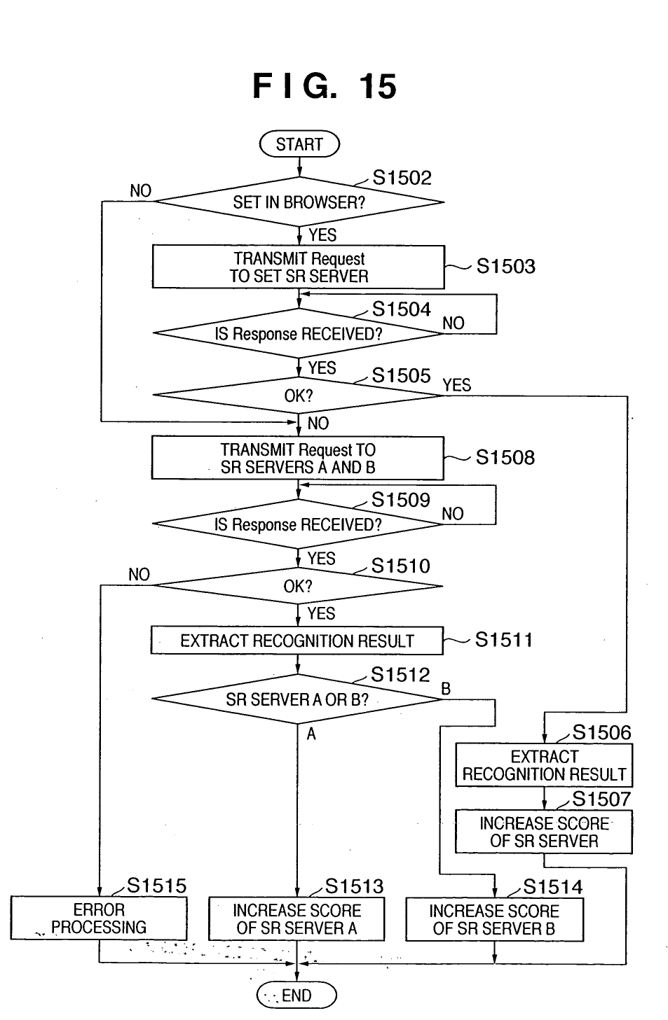

FIG. 15 is a flowchart for explaining the flow of processing between a client 102 and SR (Speech Recognition) servers 110 in the speech processing system according to the third embodiment of the present invention. First, the client determines whether a desired SR (Speech Recognition) server is set in a browser (step S1502). If a speech recognition server is set (Yes), the client transmits a request to this speech recognition server (step S1503). When receiving a response from the speech recognition server as the transmission destination (Yes in step S1504), the client analyzes the contents of the response, and determines, from the header of the response as shown in FIG. 11, whether the transmitted request is normally accepted (step S1505).

If the transmitted request is normally accepted (Yes in step S1505), the client extracts a recognition result from the response by using tags representing the recognition result (step S1506). In addition, the client increases the score as shown in FIG. 2 of this SR server (step S1507).

If the request is normally accepted (No in step S1505) because, for example, the SR server as the transmission destination is down or an error has occurred, or if no speech recognition server is set in the browser (No in step S1502), requests are transmitted to both the SR servers A and B (step S1508).

When receiving a response from one of the two servers which has a higher response speed (Yes in step S1509), the client analyzes the contents of the response, and determines whether the transmitted request is normally accepted (step S1510). If the transmitted request is normally accepted (Yes), the client extracts a recognition result from the response (step S1511). One of the two servers which has transmitted the response can be identified from the header of the response (step S1512). Therefore, the client increases the score as shown in FIG. 2 of the server by using the recognition result (step S1513 or step S1514).

On the other hand, if the transmitted request is not normally accepted (No in step S1510), the client performs error processing, for example, notifies the event (step S1515). If one of the servers cannot normally accept the request, the client may also wait for a response from the other server. A user himself or herself can also designate, from a browser, a plurality of servers, and the rule that a recognition result from a speech recognition server having a highest response speed is used.

That is, the client 102 of the speech processing system according to this embodiment is characterized by designating a plurality of speech recognition servers to be used to process input speech, transmitting speech data to the designated speech recognition servers via a communication unit 103, and allowing the communication unit 103 to receive speech data recognition results from the speech recognition servers, and select a predetermined one of the recognition results received from the speech recognition servers. This embodiment is characterized in that the communication unit 103 selects a recognition result of speech data, which is received first, of speech data processed in a plurality of speech recognition servers, that is, selects a recognition result from a speech recognition server having a highest response speed.

In the third embodiment as described above, when SR (Speech Recognition) servers connected to a network are to be used, a plurality of servers are designated, and a recognition result from a speech recognition server having a highest response speed is used. Therefore, the system can effectively operate even when the speed is regarded as important or a certain server is down. Also, since a server and the like can be designated by document written in the markup language, an advanced speech recognition system as described above can be readily constructed. In addition, it is possible, from a browser, to designate a plurality of servers, and the rule that a recognition result from a speech recognition server having a highest response speed is used. This allows not only an application developer but also a user himself or herself to easily select a server.

<Fourth Embodiment>

The fourth embodiment of the speech processing according to the present invention will be described below. In this embodiment, of recognition results from a plurality of designated speech recognition servers, the most frequent recognition results are used.

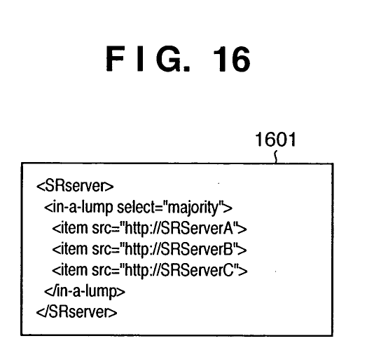

FIG. 16 is a view showing an example of the description of a document written in the markup language when three speech recognition servers are designated in a speech processing system according to the fourth embodiment. Referring to FIG. 16, <item/> tags designate the URIs of the speech recognition servers, <in-a-lump> tags designate the rule that requests are transmitted to all servers at once, and an attribute select=“majority” designates the rule that the most frequent recognition results of server's recognition results are used. That is, in this embodiment, requests are transmitted to described servers A, B, and C, and the most frequent recognition results of the three recognition results are used. However, if a desired server is set in a browser, this set server is preferentially used.

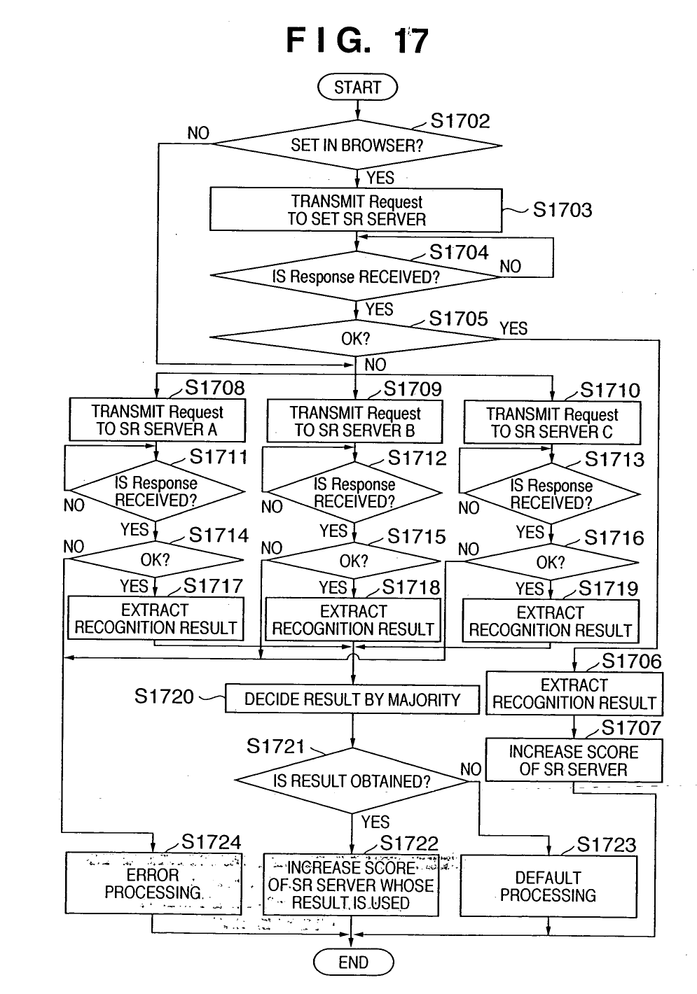

FIG. 17 is a flowchart for explaining the flow of processing between a client 102 and SR (Speech Recognition) servers 110 in the speech recognition system according to the fourth embodiment of the present invention. First, the client determines whether a speech recognition server to be used is set in a browser (step S1702). If a speech recognition server is set in the browser (Yes), the client transmits a request to the set speech recognition server (step S1703). When receiving a response from this speech recognition server (Yes in step S1704), the client analyzes the contents of the response, and, on the basis of the header of the response as shown in FIG. 11, determines whether the transmitted request is normally accepted by the speech recognition server (step S1705).

If the transmitted request is normally accepted (Yes), the client extracts a recognition result by parsing the response (step S1706). In addition, the client increases the score as shown in FIG. 2 of the SR server (step S1707).

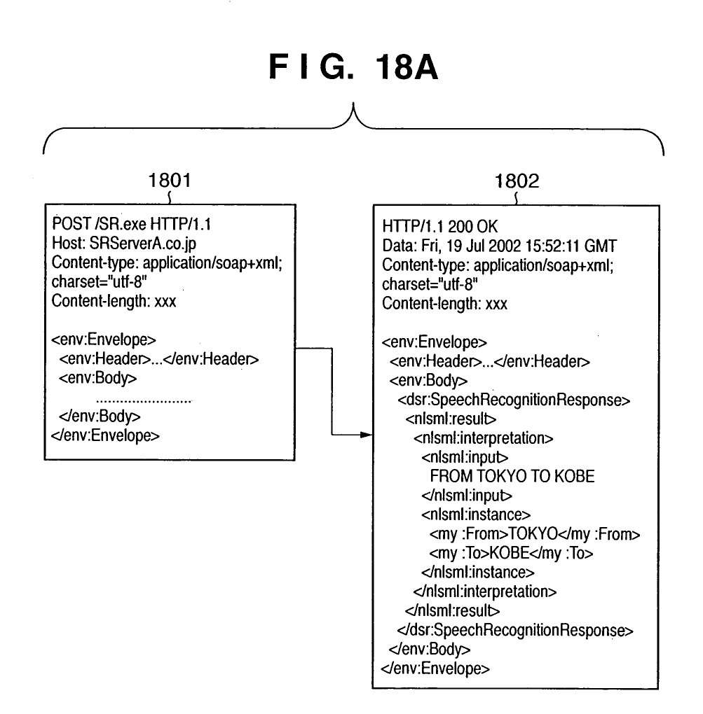

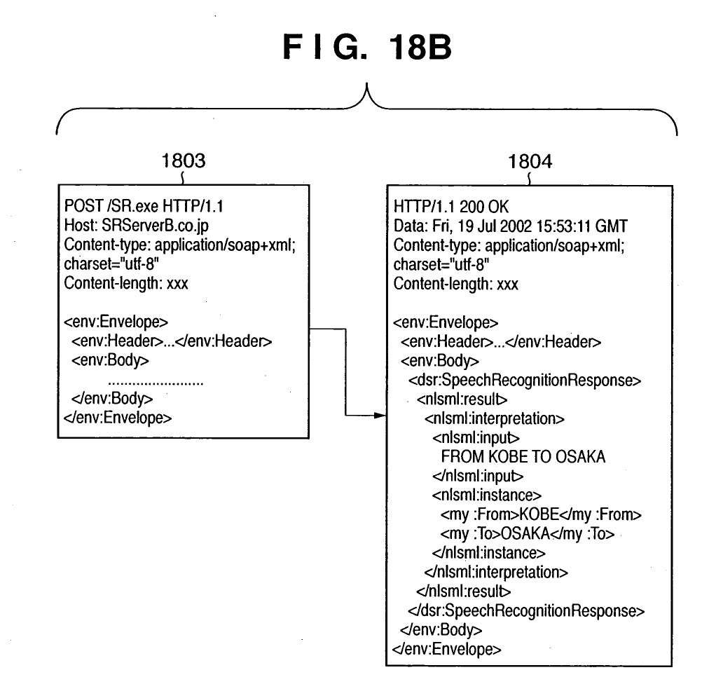

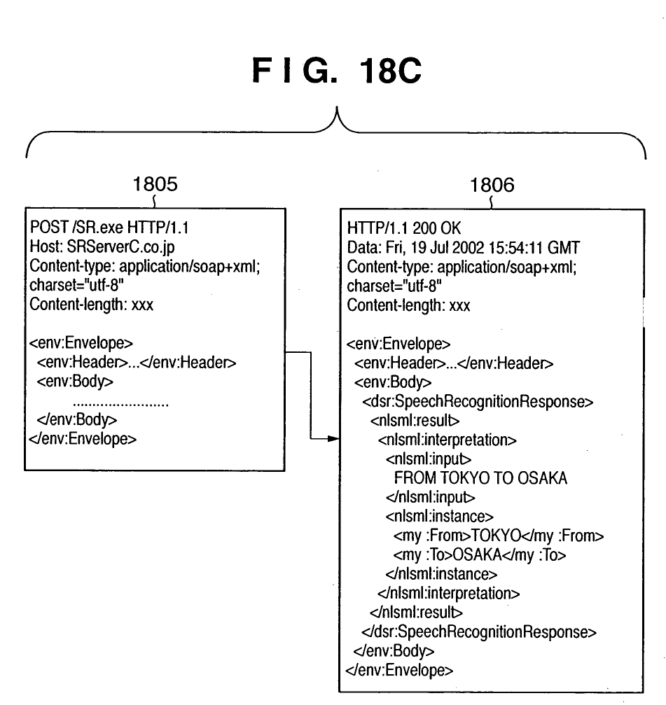

If the request is not normally accepted (No in step S1705) because, for example, the speech recognition server is down or an error has occurred, of if no speech recognition server is set in the browser (No in step S1702), requests are transmitted to the SR servers A, B, and C (steps S1708, S1709, and S1710, respectively). FIGS. 18A, 18B, and 18C are views for explaining examples of requests to be transmitted to the SR servers A, B, and C, and examples of responses from the SR servers A, B, and C, respectively, in the fourth embodiment.

That is, the client transmits requests indicated by 1801, 1803, and 1805 in FIGS. 18A, 18B, and 18C to the SR servers A, B, and C (steps S1708, S1709, and S1710, respectively). Then, the client determines whether responses as indicated by 1802, 1804, and 1806 in FIGS. 18A, 18B, and 18C are received from these servers (steps S1711, S1712, and S1713, respectively). If the responses are received, the client analyzes the contents of the responses, and determines whether the transmitted requests are normally accepted (steps S1714, S1715, and S1716). If the transmitted requests are normally accepted (Yes), the client extracts recognition results by parsing the responses (steps S1717, S1718, and S1719).

If the transmitted requests are not normally accepted (No in steps S1714, S1715, and S1716), the client performs error processing, for example, notifies the event (step S1724).

After the recognition results from the three servers are obtained by the recognition result extracting processes in steps S1717 to S1719, the client uses the most frequent recognition results of the three recognition results (step S1720). In the examples shown in FIGS. 18A to 18C, <my:From> tags in the recognition results from the SR servers A, B, and C indicate “Tokyo”, “Kobe”, and “Tokyo”, respectively, so the most frequent recognition results “Tokyo” are used. Likewise, <my:To> tags in the recognition results from the SR servers A, B, and C indicate “Kobe”, “Osaka”, and “Osaka”, respectively, so the most frequent recognition results “Osaka” are used.

The client then determines whether the most frequent recognition results are thus obtained (step S1721). If the most frequent recognition results are obtained (Yes), the client increases the scores as shown in FIG. 2 of all servers whose results are used (step S1722). In the examples shown in FIGS. 18A to 18C, the client increases the scores of the SR servers A and C in relation to the <my:From> tag, and increases the scores of the SR servers B and C in relation to the <my:To> tag.

Next, processing when the most frequent recognition results are not obtained in step S1721 will be explained below. For example, if the request is not accepted by the SR server C because, for example, the server is down, although the requests are accepted by the SR servers A and B, or if all the output results from the SR servers A to C are different, the most frequent recognition results cannot be obtained. If this is the case in this embodiment, therefore, default processing prepared beforehand is executed (step S1723), for example, the result from a server described earliest by the <item/> tags is used.

A user himself or herself can also designate, from a browser, a plurality of SR servers, and the rule that the most frequent recognition results of recognition results from the designated SR servers are used. Also, although the above example is explained by using three servers, this embodiment is similarly applicable to a system using four or more servers.

That is, in the third embodiment described previously, a recognition result from a speech recognition server having a highest response speed is used. By contrast, this embodiment is characterized in that most frequently received processing results are selected from recognition results obtained by a plurality of servers.

In the fourth embodiment as described above, when speech recognition servers connected to a network are to be used, a plurality of SR servers are designated, and the most frequent recognition results of all recognition results are used. As a consequence, a system having a high recognition ratio can be provided to a user. Also, the system can flexibly operate even when a server is down or an error has occurred. In addition, since servers and the like can be designated by document written in the markup language, an advanced speech recognition system as described above can be easily constructed and used. Furthermore, it is possible, from a browser, to designate a plurality of SR servers, and the rule that the most frequent recognition results of all recognition results from the designated SR servers are used. This allows not only an application developer but also a user himself or herself to readily select a server and the like.

<Fifth Embodiment>

The fifth embodiment of the speech processing according to the present invention will be described below. In this embodiment, a recognition result is obtained on the basis of the confidences of recognition results from a plurality of designated speech recognition servers.

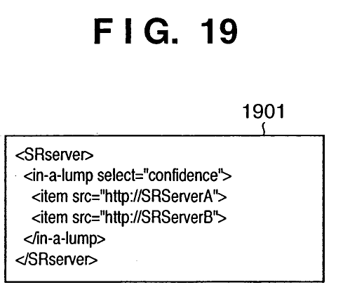

FIG. 19 is a view showing an example of the description of a document written in the markup language when two speech recognition servers are designated in a speech processing system according to the fifth embodiment of the present invention. Referring to FIG. 19, <item/> tags designate the URIs of the speech recognition servers, <in-a-lump> tags designate the rule that requests are transmitted to all servers at once, and an attribute select=“confidence” designates the rule that a recognition result is obtained from server's recognition results on the basis of the confidence. In this embodiment, therefore, requests are transmitted to described SR servers A and B, and a recognition result is obtained on the basis of the confidences of recognition results from the two servers. However, if a desired server is set in a browser, this set server is preferentially used.

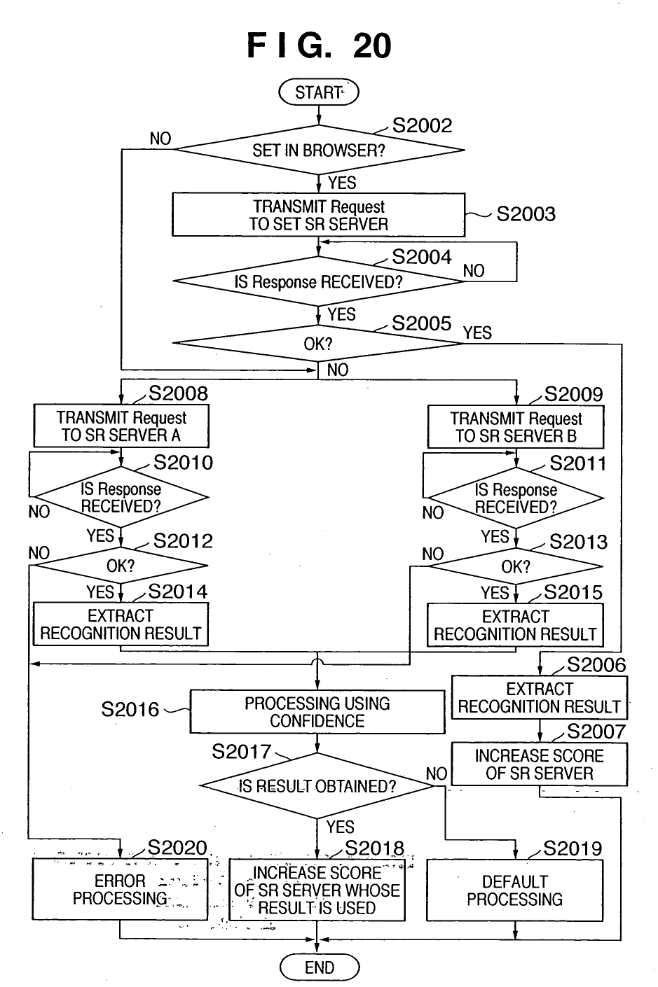

FIG. 20 is a flowchart for explaining the flow of processing between a client 102 and SR (Speech Recognition) servers 110 in the speech recognition system according to the fifth embodiment of the present invention. First, the client determines whether a speech recognition server is set in a browser (step S2002). If a speech recognition server is set in the browser (Yes), the client transmits a request to the set speech recognition server (step S2003). When receiving a response from this speech recognition server (Yes in step S2004), the client analyzes the contents of the response, and, on the basis of the header of the response as shown in FIG. 11, determines whether the transmitted request is normally accepted (step S2005).

If the transmitted request is normally accepted (Yes), the client extracts a recognition result by parsing the response (step S2006). In addition, the client increases the score as shown in FIG. 2 of the SR server (step S2007).

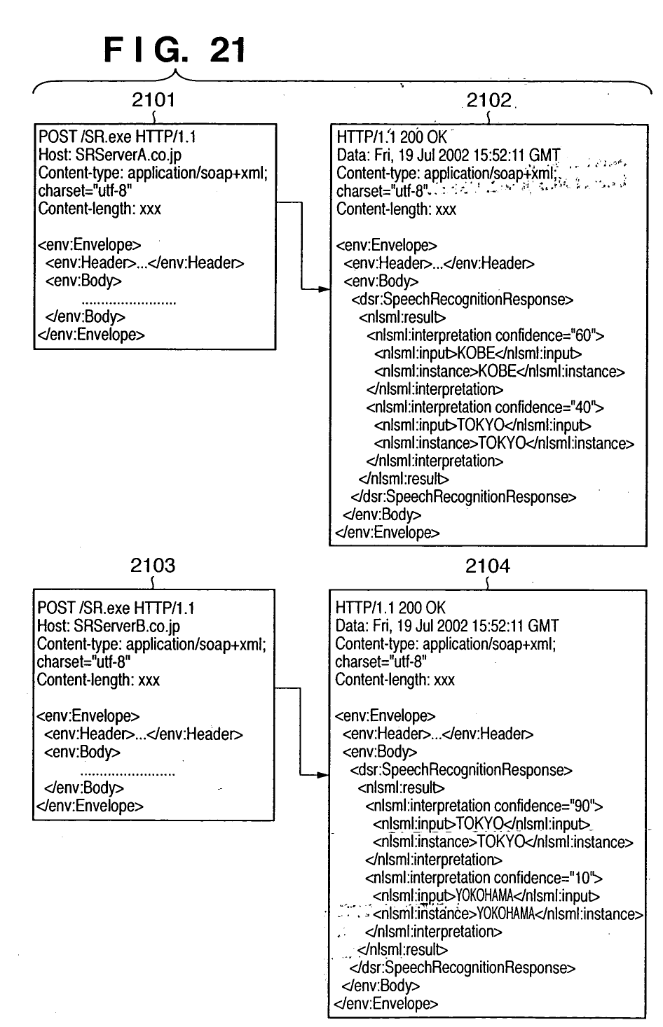

If the request is not normally accepted (No in step S2005) because, for example, the speech recognition server is down or an error has occurred, or if no speech recognition server is set in the browser (No in step S2002), requests are transmitted to the SR servers A and B (steps S2008 and S2009, respectively). FIG. 21 is a view for explaining examples of requests to be transmitted to the SR servers A and B, and examples of responses from the SR servers A and B in the fifth embodiment.

The client then determines whether responses (a response 2102 from the SR server A, and a response 2104 from the SR server B) are received from these servers (steps S2010 and S2011, respectively). If the responses are received from the SR servers, the client analyzes the contents of the responses, and determines whether the transmitted requests are normally accepted (steps S2012 and S2013). If the transmitted requests are normally accepted, the client extracts recognition results from the responses (steps S2014 and S2015).

If the transmitted requests are not normally accepted (No in steps S2012 and S2013), the client performs error processing, for example, notifies the event (step 2020).

After the recognition results from the two servers (SR servers A and B) are obtained by the recognition result extracting processes in steps S2014 and S2015, the client obtains a recognition result on the basis of the confidences of the recognition results from the two servers (step S2016). For example, a recognition result having a highest confidence can be selected in this processing. Alternatively, a recognition result can be selected on the basis of the degree of localization of the highest confidence of each server.

In the examples shown in FIG. 21, “Kobe” (confidence=60) and “Tokyo” (confidence=40) are obtained as recognition results from the SR server A, and “Tokyo” (confidence=90) and “Yokohama” (confidence=10) are obtained as recognition results from the SR server B. Assuming that the degree of confidence is “the highest confidence/the sum of confidences”, the degree of localization of the highest confidence of the SR server A is 0.6, and the degree of localization of the highest confidence of the SR server B is 0.9. That is, the localization degree of the confidence of the SR server B is higher, so the recognition result is “Tokyo”.

The client then determines whether a recognition result is thus obtained on the basis of the confidence (step S2017). If a recognition result is obtained (Yes), the client increases the score as shown in FIG. 2 of the server whose result is used (step S2018). In the examples shown in FIG. 21, the client increases the score of the SR server B.

Next, processing when no recognition result based on the confidence is obtained in step S2017 will be explained below. For example, if all recognition results have the same confidence, no recognition result can be determined on the basis of the confidence. If this is the case in this embodiment, therefore, default processing prepared beforehand is executed (step S2019), for example, a result from a server described earliest by the <item/> tags is used.

A user himself or herself can also designate, from a browser, a plurality of SR servers, and the rule that a recognition result is obtained on the basis of the confidences of recognition results from the designated SR servers.

That is, in the forth embodiment described previously, most frequently received processing results are used. By contrast, this embodiment is characterized in that a recognition result is selected on the basis of the confidences of recognition results from a plurality of speech recognition servers.

In the fifth embodiment as described above, when speech recognition servers connected to a network are to be used, a plurality of SR servers are designated, and a recognition result is obtained on the basis of the confidences of recognition results from these servers. As a consequence, a system having a high recognition ratio can be provided to a user. Also, the system can flexibly operate even when a certain server is down or an error has occurred. In addition, since servers and the like can be designated by document written in the markup language, an advanced speech recognition system as described above can be easily constructed and used. Furthermore, it is possible, from a browser, to designate a plurality of SR servers, and the rule that a recognition result is obtained on the basis of the confidences of recognition results from the designated SR servers. This allows not only an application developer but also a user himself or herself to readily select a server and the like.

<Sixth Embodiment>

The sixth embodiment of the method of speech processing according to the present invention will be described below. In this embodiment, a speech recognition server to be used is selected on the basis of the reliability indicated by the past log.

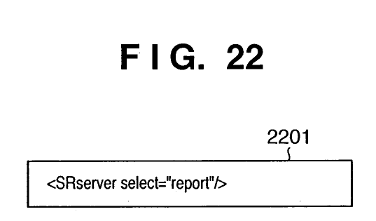

FIG. 22 is a view showing an example of the description of a document written in the markup language when two speech recognition servers are designated in a speech processing system according to the sixth embodiment of the present invention. In this embodiment as shown in FIG. 22, an attribute select=“report” of a <SRserver/> tag designates the rule that a speech recognition server to be used is selected on the basis of the reliabilities indicated by the past logs of all speech recognition servers which a client holds. As the past log, it is possible to use the log of a server whose score increases or decreases as shown in FIG. 2. However, if a desired server is set in a browser, this set server is preferentially used.

As described earlier, the scores of speech recognition servers are stored in a storage unit 104 of a client 102 as indicated by 201 in FIG. 2. For example, the score is increased when the client uses a result returned from the server, and decreased when the result is wrong (when wrong recognition is performed). The server scores are held by using this reference. Whether a result is wrong can be determined in accordance with, for example, whether the user has tried speech recognition again.

Also, when a multimodal user interface including a plurality of modalities is used, for example, when a speech UI and GUI are used together, correction is sometimes performed by a modality, such as a keyboard or GUI, different from speech. When a recognition result received from a server is thus corrected on the client side, the score of the server is decreased. It is also possible to add the reference that, for example, the score is increased when the server normally accepts a request transmitted by the client, and decreased when the server cannot normally accept the transmitted request because, for example, the server is down or an error has occurred on the server.

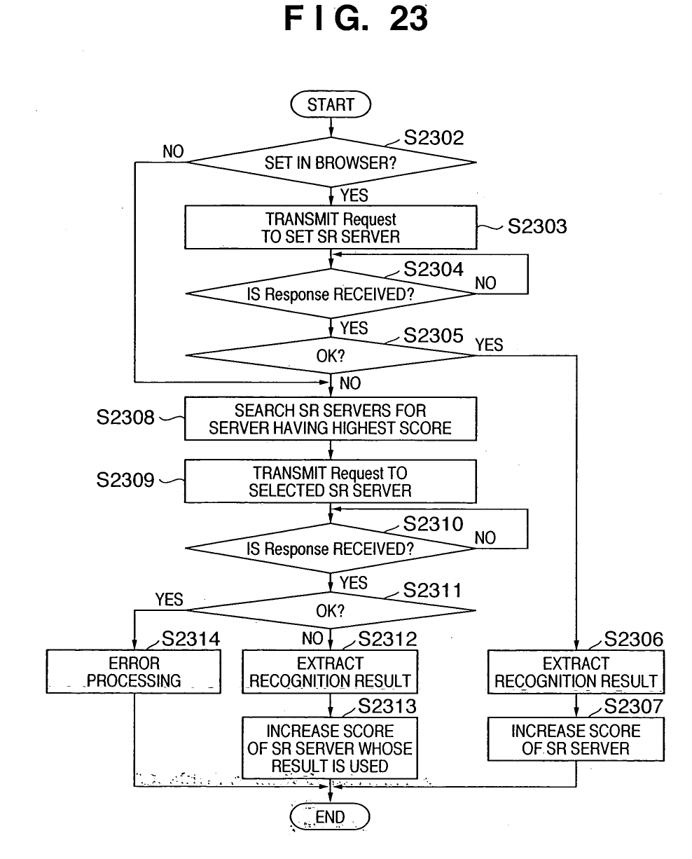

FIG. 23 is a flowchart for explaining the flow of processing between the client 102 and SR (Speech Recognition) servers 110 in the speech recognition system according to the sixth embodiment of the present invention. First, the client determines whether a speech recognition server to be used is set in a browser (step S2302). If a speech recognition server is set in the browser (Yes), the client transmits a request to the set speech recognition server (step S2303). The client then determines whether a response is received from this speech recognition server (step S2304). If the response is received (Yes), the client analyzes the contents of the response, and, on the basis of the header of the response as shown in FIG. 11, determines whether the transmitted request is normally accepted (step S2305).

If the transmitted request is normally accepted (Yes), the client extracts a recognition result by parsing the response (step S2306). Then, the client increases the score as shown in FIG. 2 of the SR server (step S2307).

If the request is not normally accepted (No in step S2305) because, for example, the set speech recognition server is down or an error has occurred, or if no speech recognition server is set in the browser (No in step S2302), the client searches the past logs as shown in FIG. 2 of all speech recognition servers which the client holds, for a speech recognition server having the highest score (step S2308). Note that the existing method such as bubble sorting can be used as the search method.

From the result of search in step S2308, the client determines a speech recognition server having a highest score. If a plurality of SR servers having the same score are found, the client selects one of them. The client then transmits a request to the selected SR (Speech Recognition) server (step S2309).

When receiving a response from this SR server as the transmission destination (Yes in step S2310), the client analyzes the contents of the response, and determines whether the transmitted request is normally accepted (step S2311). If the transmitted request is normally accepted (Yes), the client extracts a recognition result from the response (step S2312), and increases the score as shown in FIG. 2 of the SR server whose result is used (step S2313). If the transmitted request is not normally accepted (No in step S2311), the client performs error processing, for example, notifies the event (step 2314).

A user himself or herself can also designate, from a browser, the rule that a speech recognition server to be used is selected on the basis of the reliability indicated by the past log.

That is, this embodiment is characterized in that the client 102 further includes the storage unit 104 for storing the log of a speech recognition server capable of recognizing speech data, and, on the basis of the log stored in the storage unit 104, a speech recognition server to be used to recognize speech data is designated. For example, the score of each speech recognition server is calculated from the number of times of access, the number of times of use, the number of times of wrong processing, the number of errors, and the like as parameters. The storage unit 104 stores the calculated score as log data, and a speech recognition server whose stored log data has a highest score is designated.

In the sixth embodiment as described above, when speech recognition servers connected to a network are to be used, an SR server is selected on the basis of the server's reliability indicated by the past log. As a consequence, a system having high accuracy can be provided to a user. Since a user can be unaware of the server's reliability indicated by the past log, the user can use the system very easily. In addition, since servers and the like can be designated by document written in the markup language, an advanced speech recognition system as described above can be easily constructed and used. Furthermore, it is possible, from a browser, to designate the rule that a speech recognition server to be used is selected on the basis of the reliability indicated by the past log. This allows not only an application developer but also a user himself or herself to readily select a server and the like.

<Seventh Embodiment>

The seventh embodiment of the method of speech processing according to the present invention will be described below. In the first to sixth embodiments described above, a client uses a speech recognition server. In this embodiment, a client uses a speech synthesizing server.

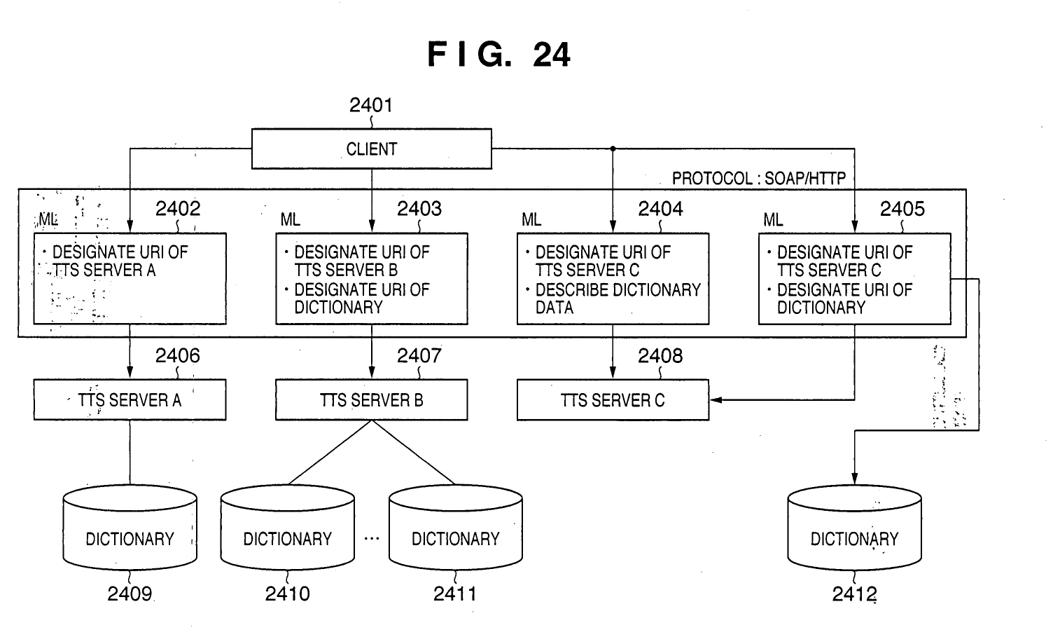

FIG. 24 is a view for explaining the relationship between speech synthesizing a server, word pronunciation dictionaries for synthesizing speech, and a client. In FIG. 24, reference numeral 2401 denotes a client such as a portable terminal 102 in FIG. 1; 2406 to 2408, speech synthesizing servers taking the form of Web service; and 2409 to 2412, word pronunciation dictionaries. These components communicate with each other by using SOAP (Simple Object Access Protocol)/HTTP (Hyper Text Transfer Protocol). The speech synthesizing server is the prior art, so an explanation thereof will be omitted in this embodiment. In this embodiment, a method of using the speech synthesizing servers 2406 to 2408 from the client 2401 will be described below.

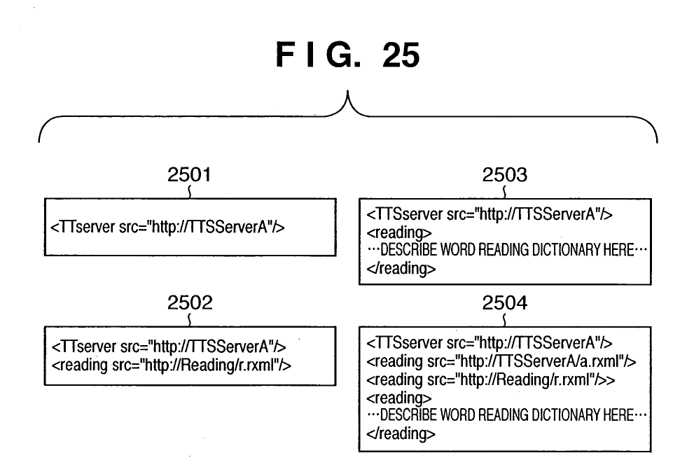

FIG. 25 is a view showing examples of the descriptions of documents related to a speech synthesizing server A and a word pronunciation dictionary in a speech synthesizing system according to the seventh embodiment. That is, when the client 2401 is to use the speech synthesizing server A (TTS server A) (2406) taking the form of Web service in FIG. 24, the location of the TTS server A (2406) is designated by a URI (Uniform Resource Identifier) as indicated by 2501 in FIG. 25 in a document described in the markup language.

The word pronunciation dictionary 2409 is registered in the TTS server A (2406). Therefore, the TTS server A (2406) uses the dictionary 2409 unless the client explicitly designates a dictionary. For example, if the client wants to use another dictionary such as the dictionary 2412, the client designates, by using a URI, the location of this dictionary to be used in a document described in the markup language, as indicated by 2502 in FIG. 25. It is also possible to directly describe a dictionaryin the markup language, as indicated by 2503 in FIG. 25.

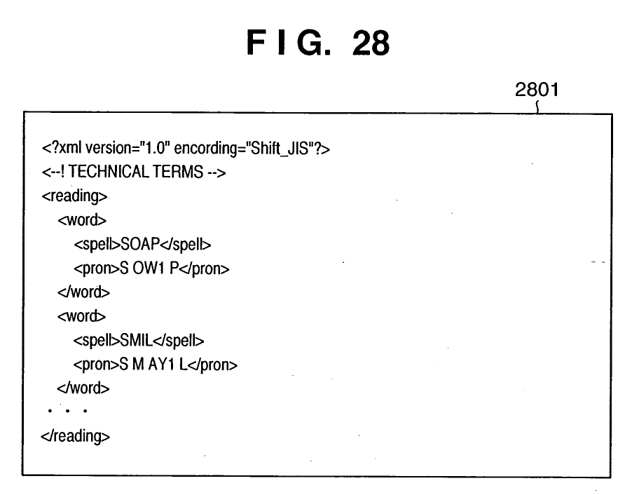

FIG. 28 is a view showing an example of the dictionary in the seventh embodiment. In this embodiment as shown in FIG. 28, the dictionary describes spelling, reading, and accent. As indicated by 2504 in FIG. 25, a plurality of dictionaries can be designated. Alternatively, designation of a dictionary by the URI and a description written in the markup language can be combined.

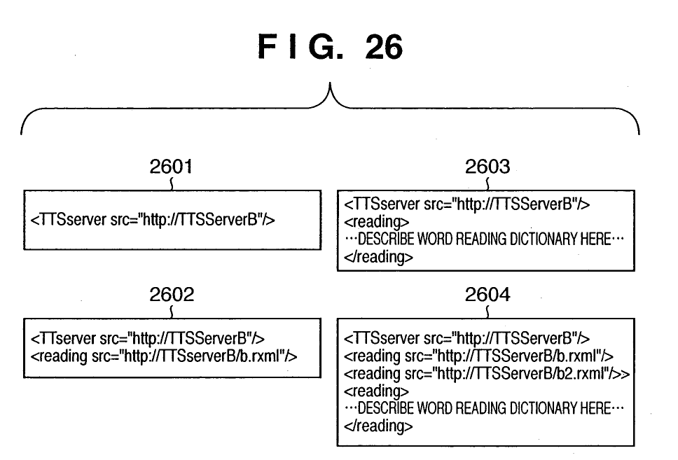

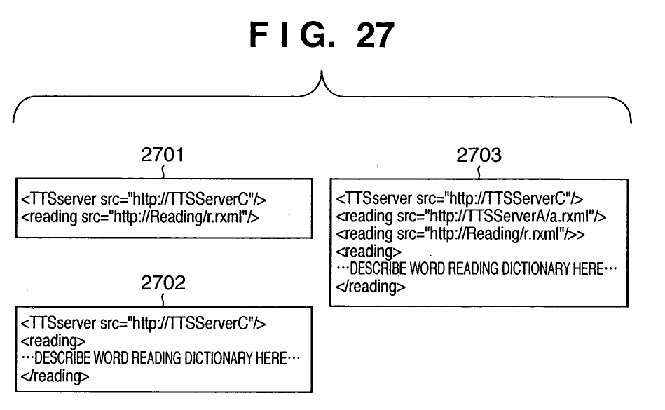

In the speech synthesizing system shown in FIG. 24, a TTS server B (2407) and TTS server C (2408) can be used in the same manner as explained for the speech recognition servers in the first embodiment, as shown in FIGS. 26 and 27. That is, FIG. 26 is a view showing examples of the descriptions of documents related to the speech synthesizing server B and the dictionary in the speech synthesizing system according to the seventh embodiment. FIG. 27 is a view showing examples of the descriptions of documents related to the speech synthesizing server C and the dictionary in the speech synthesizing system according to the seventh embodiment.

A user himself or herself can also designate a speech synthesizing server and dictionary from a browser.

In the second embodiment described previously, a client uses a speech recognition server in accordance with the priority order. By using a similar method, a client may also use a speech synthesizing server in accordance with the priority order. A user himself or herself can also designate, from a browser, a plurality of speech synthesizing servers, and the rule that these speech synthesizing servers are used in accordance with the priority order. Also, in the third embodiment described previously, a recognition result from one of a plurality of designated speech recognition servers, which has a highest response speed is used. It is possible by using a similar method to use one of a plurality of designated speech synthesizing servers, which has a highest response speed. A user himself or herself can also designate, from a browser, a plurality of speech synthesizing servers, and the rule that a speech synthesizing server having a highest response speed is used.

In the seventh embodiment as described above, when speech synthesizing servers connected to a network are to be used, it is possible to separately select a speech synthesizing server and dictionary. Also, a system having high accuracy can be constructed by designating an appropriate server and dictionary in accordance with the contents. Furthermore, since speech synthesizing servers and dictionaries can be designated from a browser, not only an application developer but also a user himself or herself can easily select a server and the like.

Additionally, in the seventh embodiment as described above, when speech synthesizing servers connected to a network are to be used, a plurality of speech synthesizing servers are designated, and a speech synthesizing server having a highest response speed is used. Therefore, the system can operate even when the speed is regarded as important or a certain server is down. Also, since servers and the like can be designated by document written in the markup language, an advanced speech synthesizing system as described above can be readily constructed. In addition, it is also possible from a browser to designate a plurality of speech synthesizing servers, and the rule of use of these designated speech synthesizing servers. This allows not only an application developer but also a user himself or herself to easily select a server and the like.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

In the present invention as has been explained above, it is possible to select a speech processing server connected to a network and a rule to be used in this server, and to readily perform high-accuracy speech processing.

The present invention is not limited to the above embodiments and various changes and modifications can be made within the spirit and scope of the present invention. Therefore, to apprise the public of the scope of the present invention, the following claims are made.

1. A speech processing apparatus connectable across a network to at least one speech processing means for processing speech data, comprising:
acquiring means for acquiring speech data;
designating means for designating, from said speech processing means, a plurality of speech processing means to be used to process the speech data, and a priority order of said plurality of speech processing means;
transmitting means for transmitting the speech data to the speech processing means designated by said designating means; and
receiving means for receiving the speech data processed by said speech processing means according to a predetermined rule.

2. The apparatus according to claim 1, wherein said transmitting means for transmitting the speech data having highest priority in the priority order designated by said designating means, and, if the speech information is not appropriately processed by said speech processing means, transmitting the speech information to speech processing means having second priority in the designated priority order.

3. The apparatus according to claim 1, further comprising one or a plurality of holding means connected to said speech processing means, or rule designating means for designating one or a plurality of rules held in one or a plurality of holding means directly connected to the network,
wherein said receiving means receives the speech data processed by said speech processing means according to said one or plurality of rules designated by said designating means.

4. The apparatus according to claim 1, wherein said designating means designates said speech processing means on the basis of designation in which a location of said speech processing means is described in a markup language.

5. The apparatus according to claim 4, wherein said rule designating means designates the rule held in said holding means on the basis of rule designating information in which a location of said holding means is described in the markup language.

6. The apparatus according to claim 1, further comprising rule describing means for describingin a markup language, said one or plurality of rules to be used to process the speech data by said speech processing means.

7. The apparatus according to claim 3, wherein designation of a location of said speech processing means by said designating means, or designation of a location of the rule by said rule designating means is performed from a browser.

8. The apparatus according to claim 7, wherein when predetermined speech processing means is set in a browser, said designating means designates said speech processing means set in the browser in preference to the priority order.

9. The apparatus according to claim 1, further comprising storage means for storing log data of speech processing means capable of processing the speech data,
wherein said designating means designates speech processing means to be used to process the speech data, on the basis of the log data stored in said storage means.

10. The apparatus according to claim 9, further comprising calculating means for calculating a score of each speech processing means by using the number of times of access, the number of times of use, the number of times of wrong processing, and the number of errors as parameters,
wherein said storage means stores the score calculated by said calculating means as the log data, and
said designating means designates speech processing means whose log data stored in said storage means has a highest score.

11. The apparatus according to claim 1, wherein
said speech processing means is a speech recognition device which recognizes speech data on the basis of a predetermined grammatical rule, and
a speech recognition device designated by said designating means recognizes the speech data acquired by said acquiring means, on the basis of a grammatical rule designated by said rule designating means.

12. The apparatus according to claim 1, wherein
said speech processing means is a speech synthesizing device which synthesizes speech from speech data on the basis of a predetermined dictionary, and
a speech synthesizing device designated by said designating means synthesizes speech from the speech data acquired by said acquiring means, on the basis of a dictionary designated by said rule designating means.

13. A speech processing apparatus connectable across a network to at least one speech processing means for processing speech data, comprising:
acquiring means for acquiring speech data;
designating means for designating, from said speech processing means, a plurality of speech processing means to be used to process the speech data;
transmitting means for transmitting the speech data to said speech processing means designated by said designating means;
receiving means for receiving a processing result of the speech data processed by said speech processing means by using a predetermined rule; and
selecting means for selecting a processing result from the processing results received by said receiving means.

14. The apparatus according to claim 13, wherein said selecting means selects a speech data processing result received first by said receiving means from processing results of the speech data processed by said plurality of speech processing means.

15. The apparatus according to claim 13, wherein said selecting means selects most frequently received processing results of the processing results from said plurality of speech processing means.

16. The apparatus according to claim 13, wherein said selecting means selects a processing result by using confidences of the processing results from said plurality of speech processing means.

17. A speech processing method using at least one speech processing means which can be connected across a network and processes speech data, comprising:
an acquisition step of acquiring speech data;
a designation step of designating, from the speech processing means, a plurality of speech processing means to be used to process the speech data, and a priority order of the plurality of speech processing means;
a transmission step of transmitting the speech data to said speech processing means designated in the designation step; and
a reception step of receiving the speech data processed by the speech processing means by using a predetermined rule.

18. A speech processing method using at least one speech processing means which can be connected across a network and processes speech data, comprising:
an acquisition step of acquiring speech data;
a designation step of designating, from the speech processing means, a plurality of speech processing means to be used to process the speech data;
a transmission step of transmitting the speech data to the speech processing means designated in the designation step;
a reception step of receiving a processing result of the speech data processed by the speech processing means by using a predetermined rule; and
a selection step of selecting a processing result from the processing results received in the reception step.

19. A program for allowing a computer connectable across a network to at least one speech processing means for processing speech data to execute:
an acquiring procedure of acquiring speech data;
a designating procedure of designating, from said speech processing means, a plurality of speech processing means to be used to process the speech data, and a priority order of said plurality of speech processing means;
a transmitting procedure of transmitting the speech data to said speech processing means designated by said designation procedure; and
a receiving procedure of receiving the speech data processed by said speech processing means by using a predetermined rule.

20. A program for allowing a computer connectable across a network to at least one speech processing means for processing speech data to execute:
an acquiring procedure of acquiring speech data;
a designating procedure of designating, from said speech processing means, a plurality of speech processing means to be used to process the speech data;
a transmitting procedure of transmitting the speech data to said speech processing means designated by said designating procedure;
a receiving procedure of receiving a processing result of the speech data processed by said speech processing means by using a predetermined rule; and
a selecting procedure of selecting a predetermined processing result from the processing results received by said receiving procedure.

21. A computer-readable recording medium storing the program cited in claim 18.

22. A computer-readable recording medium storing the program cited in claim 19.
